(19) United States
(12) Patent Application Publication
(10) Pub. No.: US 2025/0205745 A1
(43) Pub. Date: Jun. 26, 2025

(54) OBJECT IMAGING APPARATUS AND OBJECT RECOGNITION APPARATUS

(71) Applicant: PFU LIMITED, Ishikawa (JP)

(72) Inventor: Masanobu HONGO, Ishikawa (JP)

(21) Appl. No.: 18/987,918

(22) Filed: Dec. 19, 2024

(30) Foreign Application Priority Data
Dec. 26, 2023 (JP) 2023-219692
Aug. 29, 2024 (JP) 2024-147816

(51) Int. Cl. B07C 5/342; B07C 5/36; G01N 21/84

(52) U.S. Cl. CPC B07C 5/342; B07C 5/361; G01N 21/84; B07C 2501/0054; G01N 2021/845; G01N 2201/0636

(57) ABSTRACT

An object imaging apparatus includes an imaging device facing a conveyor that conveys an object to image the object conveyed by the conveyor, a first supporter that is located on the same side as the imaging device relative to the conveyor with a space from the conveyor and is to support the imaging device, and a second supporter that is located in a second installation portion different from a first installation portion in which a conveying device including the conveyor is located and is to support the first supporter. The second supporter is provided only on one side with respect a width direction of the conveyor.

### CROSS-REFERENCE TO RELATED APPLICATIONS

This patent application is based on and claims priority pursuant to 35 U.S.C. § 119 (a) to Japanese Patent Application Nos. 2023-219692, filed on Dec. 26, 2023, and 2024-147816, filed on Aug. 29, 2024, in the Japan Patent Office, the entire disclosures of which are hereby incorporated by reference herein.

### BACKGROUND

The present disclosure relates to an object imaging apparatus and an object recognition apparatus.

Object recognition apparatuses provided in automatic recyclable waste sorting apparatuses are known. Some types of such object recognition apparatuses are installed on a frame to be adjustable in height relative to a belt conveyor as a conveying device and includes an object imaging apparatus that images recyclable waste conveyed by the belt conveyor.

### SUMMARY

An object imaging apparatus according to one aspect of the present disclosure includes an imaging device facing a conveyor that conveys an object to image the object conveyed by the conveyor, a first supporter that is located on the same side as the imaging device relative to the conveyor with a space from the conveyor and is to support the imaging device, and a second supporter that is located in a second installation portion different from a first installation portion in which a conveying device including the conveyor is located and is to support the first supporter. The second supporter is provided only on one side with respect a width direction of the conveyor.

An object recognition apparatus according to another aspect of the present disclosure includes the object imaging apparatus according to the above-described aspect and circuitry to recognize the object based on a captured image obtained by imaging the object by the imaging device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a cross-sectional view of a part of an automatic recyclable waste sorting apparatus including an object recognition apparatus according to the first embodiment;

FIG. 2 is a plan view of a part of the automatic recyclable waste sorting apparatus including the object recognition apparatus according to the first embodiment;

FIG. 3 is a cross-sectional view of an optical unit of an object imaging apparatus according to the first embodiment;

FIG. 4 is a cross-sectional view of a part of a support structure of the object imaging apparatus according to the first embodiment and a belt conveyor;

FIG. 5 is a diagram illustrating a joint in a support structure of the object imaging apparatus according to the first embodiment;

FIG. 6 is a diagram illustrating a fine adjuster in the support structure of the object imaging apparatus according to the first embodiment;

FIG. 7 is a diagram illustrating the side plates of the object imaging apparatus according to the first embodiment;

FIG. 8 is a diagram illustrating an up-down direction adjuster in a plate position adjuster of the object imaging apparatus according to the first embodiment;

FIG. 9 is a diagram illustrating a width direction adjuster in the plate position adjuster of the object imaging apparatus according to the first embodiment;

FIG. 10 is a block diagram illustrating the configuration of a controller of the object recognition apparatus according to the first embodiment;

FIG. 11 is a cross-sectional view of a part of an automatic recyclable waste sorting apparatus including an object recognition apparatus according to the second embodiment;

FIG. 12 is a plan view of a part of the automatic recyclable waste sorting apparatus including the object recognition apparatus according to the second embodiment; and

FIG. 13 is a cross-sectional view of a part of an automatic recyclable waste sorting apparatus including an object recognition apparatus according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An object imaging apparatus and an object recognition apparatus according to some embodiments are described below with reference to the drawings. The technologies of the present disclosure are not limited to those in the following description. In the following description, like reference signs denote like elements, and redundant descriptions thereof are simplified or omitted.

The drawings are illustrative, and the dimensional relationship between elements, the ratio between elements, and the like may be different from the actual ones. The drawings may include parts whose dimensional relationships and ratios are different from one another. In the present disclosure, ordinal numbers are used only for distinguishing components, members, portions, positions, directions, and the like, and do not indicate order or priority.

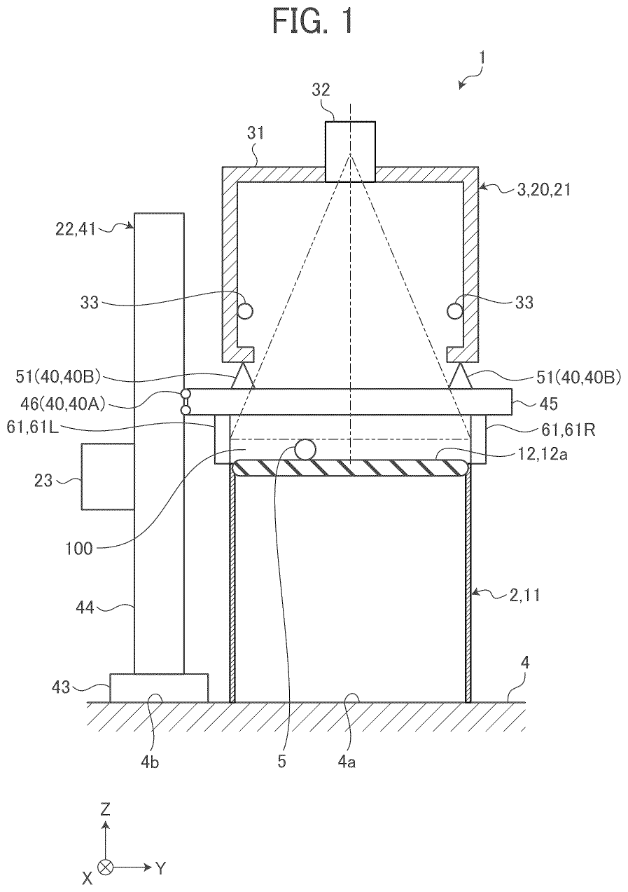

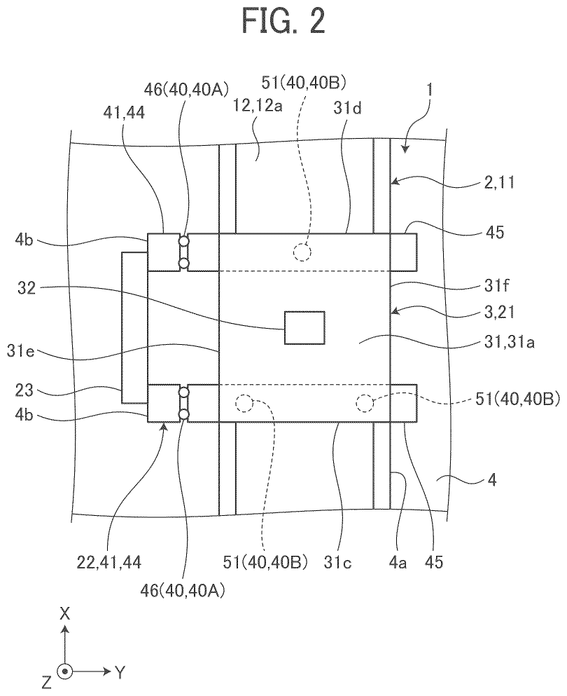

First Embodiment FIG. 1 is a cross-sectional view of a part of an automatic recyclable waste sorting apparatus 1 including an object recognition apparatus 3 according to the first embodiment. FIG. 2 is a plan view of a part of the automatic recyclable waste sorting apparatus 1 including the object recognition apparatus 3 according to the first embodiment.

As illustrated in FIG. 1 and FIG. 2, the automatic recyclable waste sorting apparatus 1 includes a belt conveyor 2, an object recognition apparatus 3, and a removal apparatus. The belt conveyor 2 conveys an object 5 such as recyclable waste. Examples of the recyclable waste include a plastic bottle and a glass bottle. The object recognition apparatus 3 images the object 5 conveyed by the belt conveyor 2 and recognizes the object 5 based on a captured image obtained by the imaging. The removal apparatus moves a recyclable waste of a particular material recognized by the object recognition apparatus 3 to a particular position. The automatic recyclable waste sorting apparatus 1 is located on a floor surface 4 of a facility such as a recyclable waste recycling facility. The belt conveyor 2 is an example of a conveying device.

The belt conveyor 2 includes a belt conveyor frame 11, a belt 12, and a belt driving source. The belt conveyor 2 is located at a first installation portion 4a of the floor surface 4. The belt conveyor 2 is an example of a conveying device, and the belt 12 is an example of a conveyor.

As illustrated in the drawings, an X-axis, a Y-axis, and a Z-axis are defined for the sake of explanatory convenience in the present disclosure. The X-axis, the Y-axis, and the Z-axis are perpendicular to each other. The X-axis is along the conveying direction of the belt conveyor 2. The Y-axis is along the width direction of the belt 12 of the belt conveyor 2. The Z-axis is along the height directions (up-down direction) of the belt conveyor 2 and the object recognition apparatus 3. The width direction of the belt 12 is also referred to as a “left-right direction.”

Further, in the present disclosure, an X-direction, a Y-direction, and a Z-direction are defined. The X-direction is a direction along the X-axis, and includes a +X-direction indicated by the arrow of the X-axis and a −X-direction opposite to the arrow of the X-axis. The Y-direction is a direction along the Y-axis, and includes a +Y-direction indicated by the arrow of the Y-axis and a −Y-direction opposite to the arrow of the Y-axis. The Z-direction is a direction along the Z-axis, and includes a +Z-direction indicated by the arrow of the Z-axis and a −Z-direction opposite to the arrow of the Z-axis. In the following description, the +Z-direction is defined as a vertically upward direction, and the −Z-direction is defined as a vertically downward direction.

The belt conveyor frame 11 is located at the first installation portion 4a of the floor surface 4. The belt 12 is formed of a flexible material and is formed into a loop-shaped band. The belt 12 is supported by the belt conveyor frame 11 via multiple pulleys. The object 5 is placed on an upper face 12a of the belt 12. The belt driving source rotates the pulleys to move the upper face 12a of the belt 12 in parallel. Thus, the upper face 12a of the belt 12 conveys the object 5 in the conveying direction (i.e., +X-direction).

The object recognition apparatus 3 includes an object imaging apparatus 20 and a controller 23. The object imaging apparatus 20 images the object 5 on the belt 12 of the belt conveyor 2. The controller 23 controls the units of the object recognition apparatus 3 and recognizes the object 5 imaged by the object imaging apparatus 20.

The object imaging apparatus 20 includes an optical unit 21, a support structure 22, and a pair of side plate 61L and side plate 61R. The optical unit 21 is located above the belt 12. The support structure 22 is located at a second installation portion 4b of the floor surface 4 and supports the optical unit 21 to adjust the position of the optical unit 21 in the up-down direction relative to the belt 12. The pair of side plate 61L and side plate 61R are located below the optical unit 21. In the following description, the pair of side plate 61L and side plate 61R may be collectively referred to as a “pair of side plates 61” or “side plates 61.” The optical unit 21 is an example of an imaging device, and the side plates 61 is an example of plates.

The optical unit 21 faces the belt 12 and images the object 5 conveyed by the belt 12. The optical unit 21 includes a housing 31, an imager 32, and multiple light sources 33.

The housing 31 is located above the upper face 12a of the belt 12 and faces the upper face 12a of the belt 12. In other words, the housing 31 faces the belt 12 in the up-down direction (i.e., Z-direction). The housing 31 is made of a material that does not transmit light.

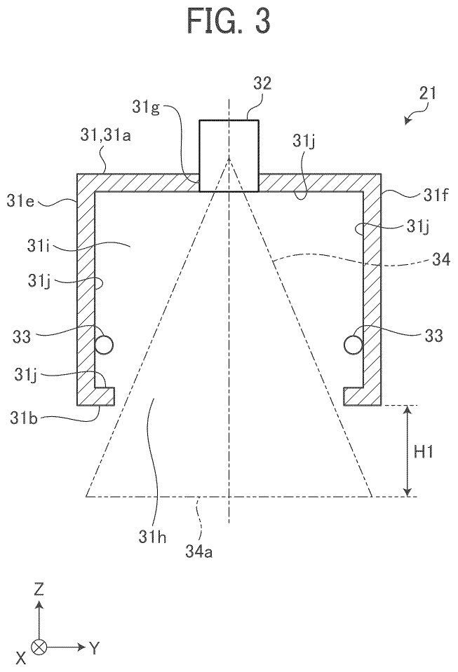

FIG. 3 is a cross-sectional view of the optical unit 21 of the object imaging apparatus 20 according to the first embodiment. As illustrated in FIG. 2 and FIG. 3, the housing 31 has, for example, a substantially rectangular parallelepiped box shape. The housing 31 has walls such as a top wall 31a, a bottom wall 31b, a front wall 31c, a rear wall 31d, a left wall 31e, and a right wall 31f. The top wall 31a is an example of a base wall. The front wall 31c, the rear wall 31d, the left wall 31e, and the right wall 31f are examples of side walls. The bottom wall 31b is also referred to as a “lower wall.” The top wall 31a is also referred to as an “upper wall.” The front wall 31c, the rear wall 31d, the left wall 31e, and the right wall 31f are also referred to as “peripheral walls.”

The top wall 31a and the bottom wall 31b extend in a direction intersecting (e.g., perpendicular to) the up-down direction (i.e., the Z-direction). In other words, the top wall 31a and the bottom wall 31b extend along the X-Y plane. The top wall 31a and the bottom wall 31b are located substantially parallel to each other with a space therebetween in the up-down direction. The top wall 31a and the bottom wall 31b may be inclined relative to the up-down direction (i.e., Z-direction). The top wall 31a includes a through-hole 31g penetrating the top wall 31a in the up-down direction. The bottom wall 31b includes a through-hole 31h penetrating the bottom wall 31b in the up-down direction.

The front wall 31c and the rear wall 31d extend in a direction perpendicular to the conveying direction (i.e., X-direction) of the belt conveyor 2. In other words, the front wall 31c and the rear wall 31d extend along the Y-Z plane. The front wall 31c and the rear wall 31d are located substantially parallel to each other with a space therebetween in the conveying direction of the belt conveyor 2. The front wall 31c and the rear wall 31d may be inclined relative to the conveying direction of the belt conveyor 2.

The left wall 31e and the right wall 31f extend in a direction perpendicular to the width direction (i.e., the Y-direction) of the belt 12 of the belt conveyor 2. In other words, the left wall 31e and the right wall 31f extend along the X-Z plane. The left wall 31e and the right wall 31f are located substantially parallel to each other with a space therebetween in the width direction of the belt 12. The left wall 31e and the right wall 31f may be inclined relative to the width direction of the belt 12.

A space 31i is provided inside the housing 31. The space 31i is surrounded by the inner faces 31j of the top wall 31a, the bottom wall 31b, the front wall 31c, the rear wall 31d, the left wall 31e, and the right wall 31f. In other words, the inner faces 31j of the top wall 31a, the bottom wall 31b, the front wall 31c, the rear wall 31d, the left wall 31e, and the right wall 31f form the space 31i. The space 31i communicates with the through-hole 31h of the bottom wall 31b, and is open to the outside of the housing 31 via the through-hole 31h. Inner faces 31j are examples of reflection faces.

The inner faces 31j of the top wall 31a, the bottom wall 31b, the front wall 31c, the rear wall 31d, the left wall 31e, and the right wall 31f are reflection faces that reflect light from the light sources 33. Specifically, the inner faces 31j diffusely reflect (irregularly reflect) light from the light sources 33.

The imager 32 is located on the top wall 31a of the housing 31. For example, the imager 32 is fitted into the through-hole 31g in the top wall 31a. An imaging area 34 of the imager 32 reaches the outside of the housing 31 through the through-hole 31h in the bottom wall 31b of the housing 31. An imaging face (focal plane) 34a on which an image imaged by the imager 32 is in focus is outside the housing 31 by a distance H1 from the bottom end of the housing 31. The imager 32 is, for example, a so-called digital camera. In other words, the imager 32 is an image sensor. For example, the imager 32 is an area image sensor. The area image sensor images (receives light) on a planar imaging plane (light-receiving plane) and generates a two-dimensional planar captured image (frame). Alternatively, the imager 32 may be a line sensor. The imager 32 images the object 5 conveyed on the upper face 12a of the belt 12 through the inside of the housing 31. In other words, the imager 32 images the object 5 conveyed on the upper face 12a of the belt 12 through the space 31i. The imager 32 outputs a captured image, which is a result of imaging. The captured image is formed of multiple pixels arranged in the image. The pixels are associated with multiple pieces of color information. Each of the pieces of color information indicates, for example, a red gradation value, a green gradation value, and a blue gradation value. The image may be a monochrome image. In this case, the color information indicates one gradation value.

As illustrated in FIG. 3, the light sources 33 are located in the space 31i of the housing 31, i.e., inside the housing 31. Specifically, the light sources 33 are located in the lower space in the housing 31 near the belt 12. The light sources 33 emit light to the inside of the housing 31. In other words, the light sources 33 emit light to the space 31i. The light sources 33 emit, for example, visible light as light. The light emitted from the light sources 33 is reflected by the inner faces 31j of the housing 31 toward the belt 12.

As illustrated in FIG. 1, the support structure 22 is located at the second installation portion 4b of the floor surface 4. The second installation portion 4b is a portion different from the first installation portion 4a at which the belt conveyor 2 is located on the floor surface 4. In other words, the second installation portion 4b is a portion different from the first installation portion 4a. The support structure 22 may be located only on one side at a predetermined distance from the belt 12 with respect to the width direction of the belt 12. The support structure 22 supports the optical unit 21 to adjust the position of the optical unit 21 relative to the belt 12 in the facing direction in which the belt 12 and the optical unit 21 face each other (i.e., the Z-direction). In the following description, the term “facing direction” refers to a direction in which the belt 12 and the optical unit 21 face each other unless otherwise specified. As illustrated in FIG. 1 and FIG. 2, the support structure 22 includes multiple (e.g., two) structures 41 and a position adjuster 40. The two structures 41 are arranged at an interval in the conveying direction of the belt conveyor 2 (i.e., X-direction).

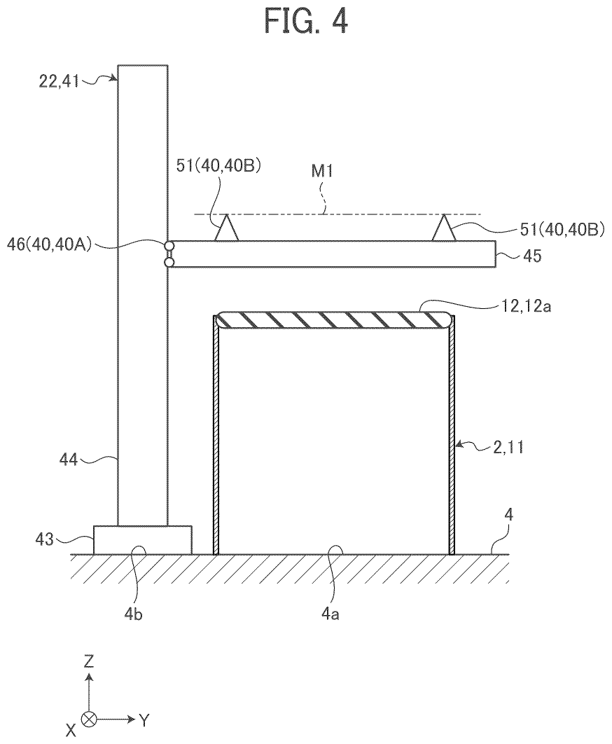

FIG. 4 is a cross-sectional view of the support structure 22 of the object imaging apparatus 20 according to the first embodiment and the belt conveyor 2. As illustrated in FIG. 4, each of the structures 41 includes a base 43, a pillar 44, a beam 45, a joint 46, and a fine adjuster 51. The pillar 44 is an example of a second supporter. The beam 45 is an example of a first supporter. The support structure 22 is also referred to as a “supporter.”

The base 43 is fixed to the second installation portion 4b of the floor surface 4. The pillar 44 is fixed to the base 43 and extends upward from the base 43. In other words, the pillar 44 extends in the facing direction in which the optical unit 21 and the belt 12 face each other, (i.e., the Z-direction). The pillar 44 is made of, for example, H-shaped steel or T-shaped steel, but is not limited thereto. The base 43 and the pillar 44 are aligned with the belt conveyor 2 in the width direction of the belt conveyor 2 (i.e., the Y-direction). In other words, the base 43 and the pillar 44 are located beside the belt conveyor 2. In other words, the pillar 44 is located only on one side with respect to the width direction of the belt 12. The base 43 and the pillar 44 are made of, for example, a metal material.

The beam 45 is coupled to the pillar 44 by the joint 46. The beam 45 is supported by the pillar 44 in a cantilever manner. In other words, the pillar 44 supports the beam 45 in a cantilever manner. The beam 45 is above the belt 12 and faces the upper face 12a of the belt 12. The optical unit 21 is located on the beam 45. The beam 45 supports the optical unit 21. In other words, the beam 45 is located on the optical unit 21 side relative to the belt 12 with a space from the belt 12, and supports the optical unit 21. The optical unit 21 is located opposite the belt 12 relative to the beam 45 and is supported by the beam 45. The two beams 45 of the two structures 41 are located with a space therebetween in the conveying direction in which the object 5 is conveyed (i.e., the X-direction).

The joint 46 fixes the beam 45 to the pillar 44 to adjust the position of the beam 45 relative to the pillar 44 in the facing direction in which the optical unit 21 and the belt 12 face each other (i.e., the Z-direction).

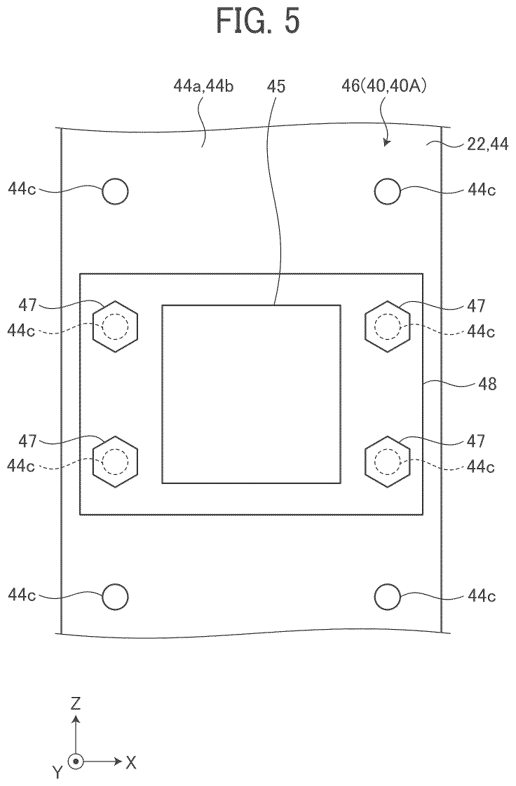

FIG. 5 is a diagram illustrating the joint 46 in the support structure 22 of the object imaging apparatus 20 according to the first embodiment. As illustrated in FIG. 5, the joint 46 includes a pillar joint 44a, a beam joint 48, multiple male screw members 47, and female screw members.

The pillar joint 44a is included in a wall 44b constituting the pillar 44. The pillar joint 44a is provided with multiple through-holes 44c. The through-holes 44c are arranged along the up-down direction, that is, the facing direction in which the belt 12 and the optical unit 21 face each other (i.e., the Z-direction). Specifically, the through-holes 44c are arranged in multiple (e.g., two) rows along the up-down direction. The two rows of the through-holes 44c are arranged with a space therebetween in the conveying direction of the belt conveyor 2 (i.e., the X-direction).

The beam joint 48 is provided at one end that is closer to the pillar 44 of the beam 45. The beam joint 48 is, for example, a flange.

The male screw members 47 are inserted into the through-holes 44c of the pillar joint 44a through the beam joint 48, and are coupled to the female screw members. The male screw members 47 couple (fix) the beam joint 48 to the pillar joint 44a with the female screw members. In other words, the male screw members 47 couple the beam 45 to the pillar 44 with the female screw members. For example, the male screw members 47 are bolts, and the female screw members are nuts. The position of the beam 45 relative to the pillar 44 in the facing direction in which the optical unit 21 and the belt 12 face each other (i.e., the Z-direction) is set to a position corresponding to one or more through-holes 44c into which the male screw members 47 are inserted among the through-holes 44c of the pillar joint 44a.

The two joints 46 of the two structures 41 constitute a first adjuster 40A. The first adjuster 40A couples the pillar 44 and the beam 45 to adjust the position of the beam 45 relative to the pillar 44 in the facing direction in which the optical unit 21 and the belt 12 face each other (i.e., the Z-direction).

As illustrated in FIG. 1 and FIG. 2, one of the two beams 45 of the two structures 41 is provided with two fine adjusters 51, and the other of the two beams 45 is provided with one fine adjuster 51. In other words, three fine adjusters 51 are provided. In other words, the fine adjusters 51 support the optical unit 21 at three points. Thus, the optical unit 21 is stably supported.

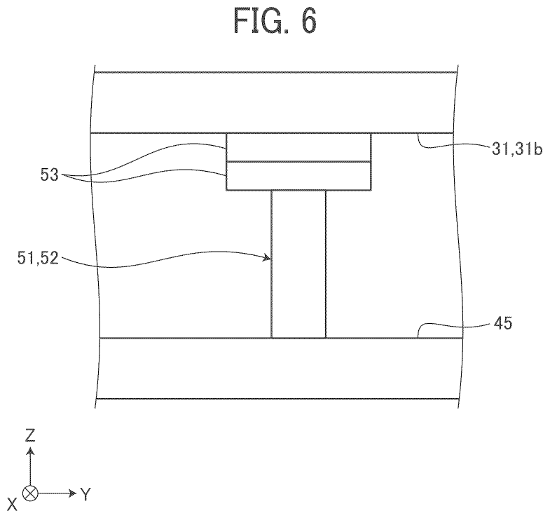

FIG. 6 is a diagram illustrating the fine adjuster 51 in the support structure 22 of the object imaging apparatus 20 according to the first embodiment. As illustrated in FIG. 6, the fine adjuster 51 includes a pin 52 and a spacer 53. The pin 52 is fixed to the upper face of the beam 45 and extends upward from the beam 45. The housing 31 of the optical unit 21 is located on the tip of the pin 52. The spacer 53 may be inserted between the tip of the pin 52 and the housing 31 as illustrated in FIG. 6. Alternatively, the spacer 53 may not be inserted. By adjusting the number of spacers 53 between the pin 52 and the housing 31, the height of the fine adjuster 51 in the up-down direction is adjusted. As a result, the height of the housing 31 in the up-down direction in contact with the fine adjuster 51 is adjusted. The movement of the spacer 53 in the direction intersecting the up-down direction may be restricted by a positioning member provided on the beam 45 or the housing 31.

The three fine adjuster 51 constitute a second adjuster 40B. The second adjuster 40B couples the optical unit 21 to the beam 45 to adjust the position of the optical unit 21 relative to the beam 45 in the facing direction in which the optical unit 21 and the belt 12 face each other (i.e., the Z-direction). By adjusting the heights of the three fine adjusters 51, the horizontality of a plane M1 passing through the tips of the three fine adjusters 51 can be adjusted. In other words, the posture of the optical unit 21 can be adjusted by adjusting the heights of the three fine adjusters 51.

The position adjuster 40 includes the first adjuster 40A and the second adjuster 40B as described above. Accordingly, the position adjuster 40 can adjust at least one (e.g., both) of the position of the beam 45 relative to the pillar 44 in the facing direction in which the optical unit 21 and the belt 12 face each other (i.e., the Z-direction) and the position of the optical unit 21 relative to the beam 45 in the facing direction. The amount (interval) by which the position of the optical unit 21 can be adjusted by the second adjuster 40B is smaller than the amount (interval) by which the position of the optical unit 21 can be adjusted by the first adjuster 40A. In other words, the first adjuster 40A is for rough adjustment of the position of the optical unit 21, and the second adjuster 40B is for fine adjustment of the position of the optical unit 21. Further, the position adjuster 40 can adjust the posture of the optical unit 21 by the second adjuster 40B.

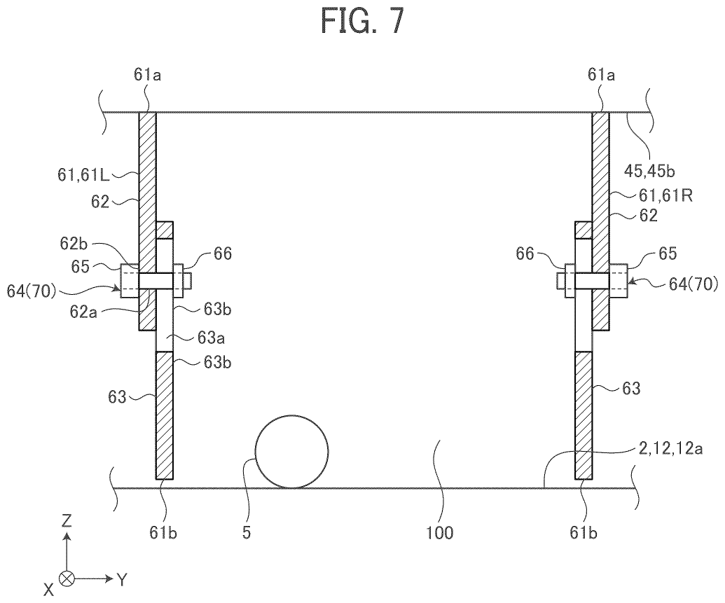

FIG. 7 is a diagram illustrating the side plates 61 of the object imaging apparatus 20 according to the first embodiment. As illustrated in FIG. 7, the pair of side plates 61 are coupled to the beam 45 and are arranged at an interval in the width direction of the belt 12 (i.e., the Y-direction). The pair of side plates 61 are not coupled to the belt conveyor frame 11 of the belt conveyor 2. The pair of side plates 61 sandwich a space 100 between the optical unit 21 and the belt 12. The optical unit 21 can image the object 5 between the pair of side plates 61.

As illustrated in FIG. 7, the side plate 61 is formed by combining multiple members. For example, each of the side plates 61 includes a first plate member 62 and a second plate member 63. The first plate member 62 includes an upper end 61a of the side plate 61. The second plate member 63 includes a lower end 61b of the side plate 61. The first plate member 62 is coupled to the beam 45. Alternatively, the side plates 61 may be attached to the lower end of the housing 31 of the optical unit 21. The side plates 61 may be coupled and attached to the beam 45 and the housing 31 in any suitable manner. The second plate member 63 is coupled to the first plate member 62 with a part of the second plate member 63 overlapping the first plate member 62. The second plate member 63 is coupled to the first plate member 62 to be slidable in the up-down direction relative to the first plate member 62.

A plate position adjuster 70 can adjust at least one (e.g., both) of the interval between the pair of side plates 61 in the width direction of the belt 12 and the positions of the pair of side plates 61 in the facing direction in which the belt 12 and the optical unit 21 face each other (i.e., the Z-direction).

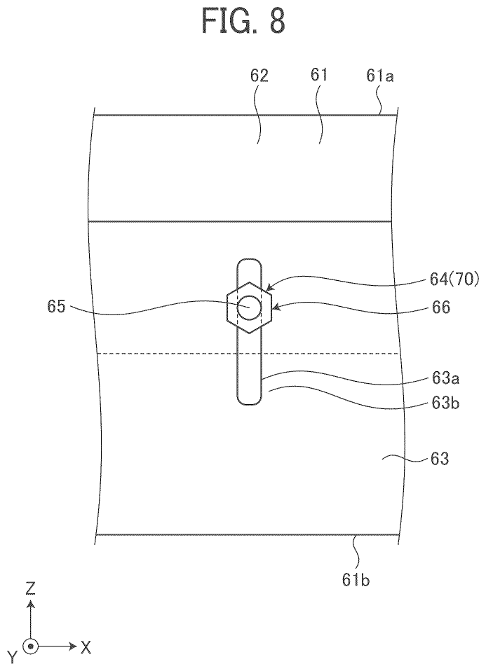

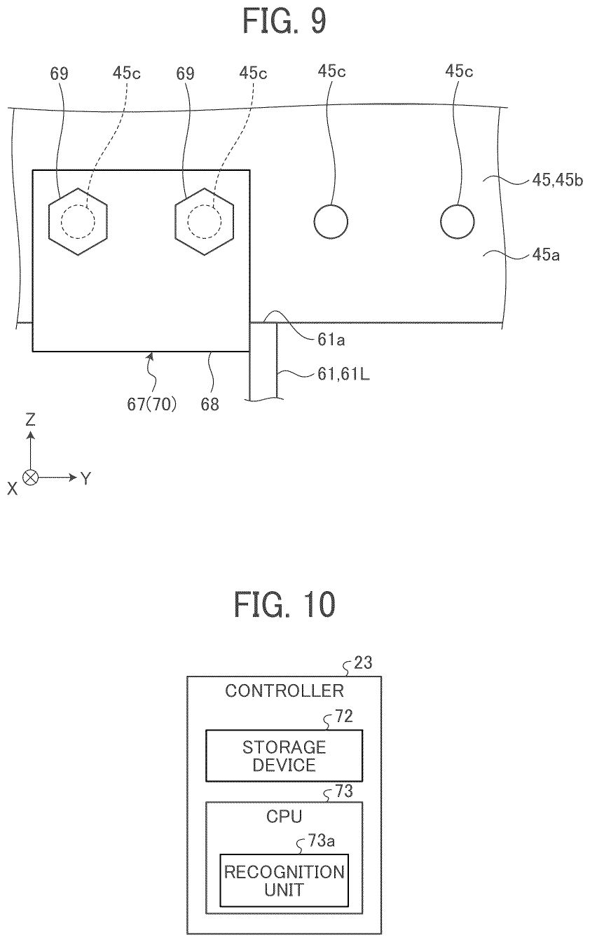

FIG. 8 is a diagram illustrating an up-down direction adjuster 64 in the plate position adjuster 70 of the object imaging apparatus 20 according to the first embodiment. FIG. 9 is a diagram illustrating a width direction adjuster 67 in the plate position adjuster 70 of the object imaging apparatus 20 according to the first embodiment. As illustrated in FIG. 7 to FIG. 9, the plate position adjuster 70 includes the up-down direction adjuster 64 (FIG. 7 and FIG. 8) and the width direction adjuster 67 (FIG. 9).

As illustrated in FIG. 7 and FIG. 8, the up-down direction adjuster 64 includes a first plate member joint 62b, a second plate member joint 63b, a male screw member 65, and a female screw member 66.

The first plate member joint 62b is a part of the first plate member 62. The first plate member joint 62b is provided with a through-hole 62a.

The second plate member joint 63b is a part of the second plate member 63. The second plate member joint 63b is provided with an elongated hole 63a of which the longitudinal direction is the up-down direction, that is, the facing direction in which the optical unit 21 and the belt 12 face each other (i.e., the Z-direction). The elongated hole 63a penetrates the second plate member 63 in the width direction of the belt 12 (i.e., the Y-direction).

The male screw member 65 is inserted into the through-hole 62a of the first plate member joint 62b and the elongated hole 63a of the second plate member joint 63b, and is coupled to the female screw member 66. The male screw member 65 couples (fixes) the second plate member 63 to the first plate member 62 with the female screw member 66. For example, the male screw member 65 is a bolt, and the female screw member 66 is a nut. This configuration allows the second plate member 63 to move relative to the first plate member 62 in the up-down direction, that is, in the facing direction in which the optical unit 21 and the belt 12 face each other (i.e., the Z-direction) when the male screw member 65 is loosened. Thus, the position of the lower end 61b of the side plate 61 is adjusted. The position of the lower end 61b of the side plate 61 is an example of the position of the side plate 61 in the up-down direction, that is, the facing direction in which the optical unit 21 and the belt 12 face each other (i.e., the Z-direction).

As illustrated in FIG. 9, the width direction adjuster 67 includes a beam joint 45a, a plate joint 68, multiple male screw members 69, and a female screw member.

The beam joint 45a is included in a wall 45b constituting the beam 45. The beam joint 45a is provided with multiple through-holes 45c. The through-holes 45c are arranged along the width direction of the belt 12 (i.e., the Y-direction).

The plate joint 68 is located in the upper end 61a of the side plate 61. The plate joint 68 is, for example, a metal fitting (e.g., bracket).

The male screw members 69 are inserted into the through-holes 45c of the beam joint 45a through the plate joint 68, and are coupled to female screw members. The male screw members 69 couple (fix) the plate joint 68 to the beam joint 45a by the female screw members. In other words, the male screw members 69 couple the side plate 61 to the beam 45 with the female screw members. For example, the male screw members 69 are bolts, and the female screw members are nuts. The position of the side plate 61 in the width direction of the belt 12 is set to a position corresponding to two or more through-holes 45c into which the male screw members 69 are inserted among the through-holes 45c of beam joint 45a. Thus, the interval between the two side plates 61 in the width direction of the belt 12 is adjusted.

FIG. 10 is a block diagram illustrating the configuration of the controller 23 of the object recognition apparatus 3 according to the first embodiment. As illustrated in FIG. 10, the controller 23 is a computer. The controller 23 includes a storage device 72 and a central processing unit (CPU) 73. The storage device 72 records a computer program to be installed in the controller 23 and records information used by the CPU 73. Examples of the storage device 72 include a memory such as a random-access memory (RAM) or a read-only memory (ROM), a fixed disk device such as a hard disk, and a solid state drive (SSD). The controller 23 may be fixed to, for example, the support structure 22 as illustrated in FIG. 1. As illustrated in FIG. 1, the controller 23 is preferably located opposite the belt 12, which is conveying means, relative to the support structure 22 to make it easy to operate the controller 23 and check a display window. However, to eliminate any protrusion in the width direction of the belt 12, the controller 23 may be located on the same side as the belt 12 relative to the support structure 22, or the controller 23 may be located on the side face of the support structure 22. Further, to increase the degree of freedom in selecting the location of the controller 23, the controller 23 may be provided separately from the support structure 22.

The CPU 73 performs various types of processing and control by executing the computer program installed in the controller 23. The computer program installed in the controller 23 includes one or multiple computer programs for causing the controller 23 to implement multiple functions. The functions include at least a recognition unit 73a. In other words, the CPU 73 implements the recognition unit 73a by executing the computer program installed in the controller 23.

The recognition unit 73a recognizes the object 5 based on a captured image obtained by imaging the object 5 by the optical unit 21. For example, the recognition unit 73a recognizes the shape, position, color, material, and the like of the object 5 by performing image processing on the captured image.

As described above, the object imaging apparatus 20 according to the present embodiment includes the optical unit 21 (the imaging device), the beam 45 (the first supporter), and the pillar 44 (the second supporter). The optical unit 21 faces the belt 12 (the conveyor) that conveys the object 5, and can image the object 5 conveyed by the belt 12. The beam 45 is located on the optical unit 21 side relative to the belt 12 with a space from the belt 12, and supports the optical unit 21. The pillar 44 is located at the second installation portion 4b different from the first installation portion 4a. The belt conveyor 2 (the conveying device) including the belt 12 is located at the first installation portion 4a. The pillar 44 supports the beam 45. The pillar 44 is provided only on one side with respect to the width direction of the belt 12.

With such a configuration, since the pillar 44 is located at the second installation portion 4b different from the first installation portion 4a, the object imaging apparatus 20 can be easily installed even when the belt conveyor 2 is preliminarily located in a facility.

The pillar 44 supports the beam 45 in a cantilever manner.

With such a configuration, the configuration of the pillar 44 (the support structure 22) can be relatively simplified.

The first supporter is the beam 45, and the two beams 45 are located at an interval in the conveying direction in which the object 5 is conveyed.

With such a configuration, the optical unit 21 can be stably supported by the two beams 45.

The object imaging apparatus 20 includes the support structure 22. The support structure 22 includes the beam 45 and the pillar 44, and can adjust the position of the optical unit 21 relative to the belt 12 in the facing direction in which the belt 12 and the optical unit 21 face each other.

With such a configuration, the position of the optical unit 21 can be adjusted in a facility. Accordingly, the distance between the optical unit 21 and the upper face 12a of the belt 12 can be set to a predetermined distance. In other words, the imaging face 34a of the imager 32 can be matched with a predetermined face to be imaged. The face to be imaged is, for example, a face located above the upper face 12a of the belt 12 by a predetermined distance. Further, with the above-described configuration, the object imaging apparatus 20 can be installed for the belt conveyor 2 having various shapes and sizes.

The support structure 22 includes the position adjuster 40. The pillar 44 extends in the facing direction (Z-direction). The beam 45 is coupled to the pillar 44, faces the belt 12, and supports the optical unit 21. The position adjuster 40 can adjust at least one of the position of the beam 45 relative to the pillar 44 in the facing direction and the position of the optical unit 21 relative to the beam 45 in the facing direction (the Z-direction).

With such a configuration, at least one of the position of the beam 45 relative to the pillar 44 in the facing direction and the position of the optical unit 21 relative to the beam 45 in the facing direction (the Z-direction) can be adjusted in a facility.

Further, the support structure 22 can adjust the posture of the optical unit 21.

With such a configuration, the posture of the optical unit 21 can be adjusted in a facility.

The position adjuster 40 includes the first adjuster 40A and the second adjuster 40B.

The first adjuster 40A couples the pillar 44 and the beam 45 to adjust the position of the beams 45 relative to the pillar 44 in the facing direction (the Z-direction). The second adjuster 40B couples the optical unit 21 to the beams 45 to adjust the position of the optical unit 21 relative to the beam 45 in the facing direction (the Z-direction). The amount by which the position of the optical unit 21 can be adjusted by the second adjuster 40B is smaller than the amount by which the position of the optical unit 21 can be adjusted by the first adjuster 40A.

With such a configuration, after the first adjuster 40A roughly adjusts the position of the optical unit 21 relative to the beam 45 in the facing direction (the Z-direction), the second adjuster 40B can finely adjust the position of the optical unit 21 relative to the beam 45 in the facing direction (the Z-direction).

The optical unit 21 is located opposite the belt 12 relative to the beam 45 and is supported by the beam 45.

With such a configuration, dust on the belt 12 is likely to be prevented from adhering to the optical unit 21.

The object imaging apparatus 20 includes the pair of side plates 61 (plates) and the plate position adjuster 70. The pair of side plates 61 are spaced apart in the width direction of the belt 12 and sandwich the space 100 between the optical unit 21 and the belt 12. The plate position adjuster 70 can adjust at least one of the interval between the pair of side plates 61 in the width direction and the positions of the pair of side plates 61 in the facing direction (the Z-direction). The optical unit 21 can image the object 5 between the pair of side plates 61.

With such a configuration, the positions of the pair of side plates 61 can be adjusted based on the arrangement of the belt conveyor 2 or the width and height of the belt conveyor 2. Further, with the above-described configuration, the pair of side plates 61 can reduce or prevent disturbance light. For example, by bringing the belt 12 and the side plate 61 into close contact with each other, disturbance light entering the inside of the optical unit 21 from a clearance between the belt 12 and the side plate 61 is reduced or eliminated.

The optical unit 21 includes the housing 31, the imager 32, and the light sources 33. The housing 31 faces the belt 12. The imager 32 can image the object 5 conveyed on the belt 12 through the inside of the housing 31. The light sources 33 emit light to the inside of the housing 31. The housing 31 has the inner faces 31j (reflection faces) that reflect light from the light sources 33 toward the belt 12.

With such a configuration, the object 5 is further irradiated with light from the light source 33.

The imager 32 is an area image sensor.

With such a configuration, an image of a wide range can be captured in one imaging (frame).

The object recognition apparatus 3 according to the present embodiment includes the object imaging apparatus 20 and the recognition unit 73a. The recognition unit 73a recognizes the object 5 based on a captured image obtained by imaging the object 5 by the optical unit 21.

With such a configuration, the object recognition apparatus 3 includes the object imaging apparatus 20 that can be easily installed, and thus the object recognition apparatus 3 can be easily installed.

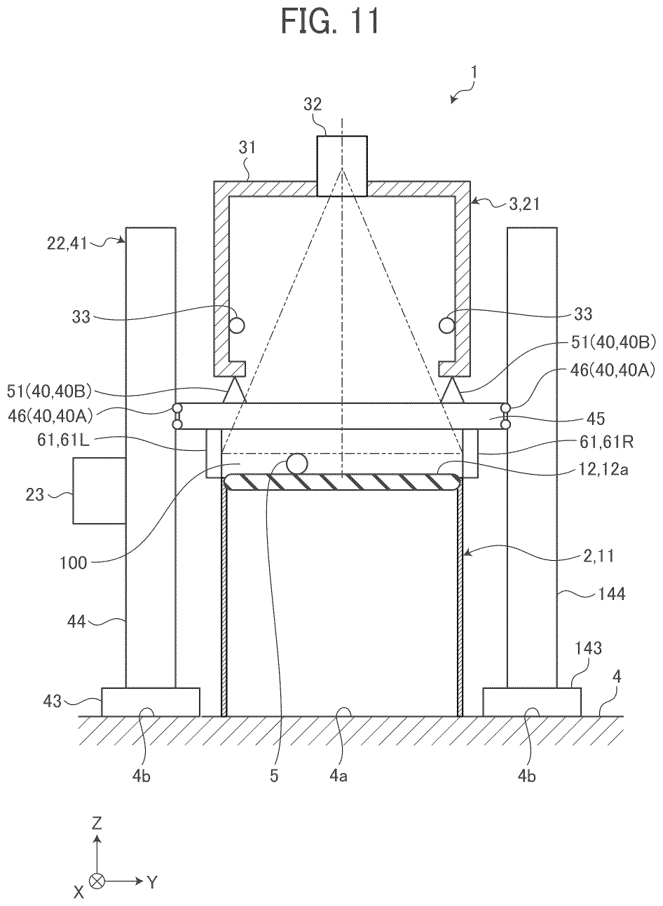

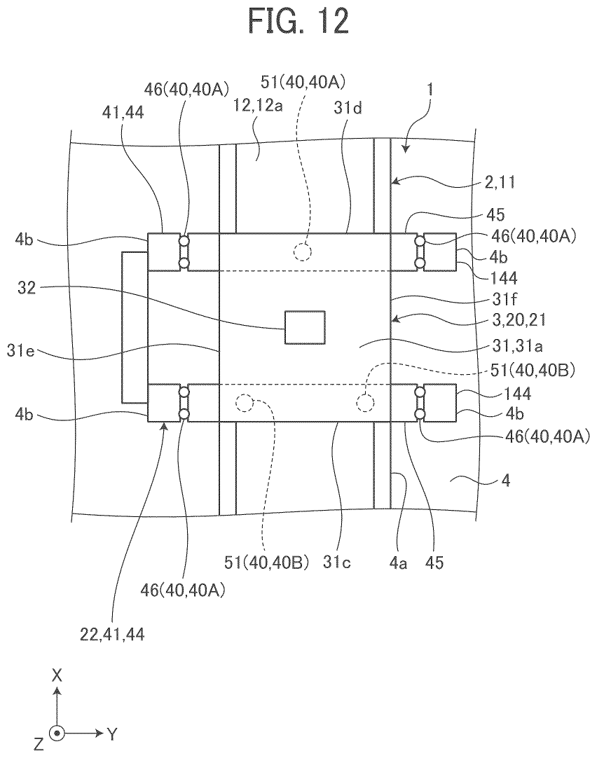

Second Embodiment FIG. 11 is a cross-sectional view of a part of the automatic recyclable waste sorting apparatus 1 including the object recognition apparatus 3 according to the second embodiment. FIG. 12 is a plan view of a part of the automatic recyclable waste sorting apparatus 1 including the object recognition apparatus 3 according to the second embodiment.

As illustrated in FIG. 11 and FIG. 12, according to the present embodiment, the structures 41 includes multiple (e.g., two) beams 45. The present embodiment is different from the first embodiment in that each of the two beams 45 is supported at both ends by two pillars, i.e., the pillar 44 and a pillar 144.

The two pillars, i.e., the pillar 44 and the pillar 144 of the structure 41 are located on both sides of the belt 12 in the width direction of the belt 12. In other words, the structure 41 has a gate-like shape. The two pillars, i.e., the pillar 44 and the pillar 144 are fixed to the second installation portion 4b of the floor surface 4 via the base 43 and a base 143, respectively. Further, each of the two pillars, i.e., the pillar 44 and the pillar 144 is provided with the joint 46.

As described above, in the present embodiment, multiple pillars 44 and multiple pillars 144 are provided. The beams 45 are supported at both ends by the multiple pillars 44 and the multiple pillars 144.

With such a configuration, the optical unit 21 can be firmly supported.

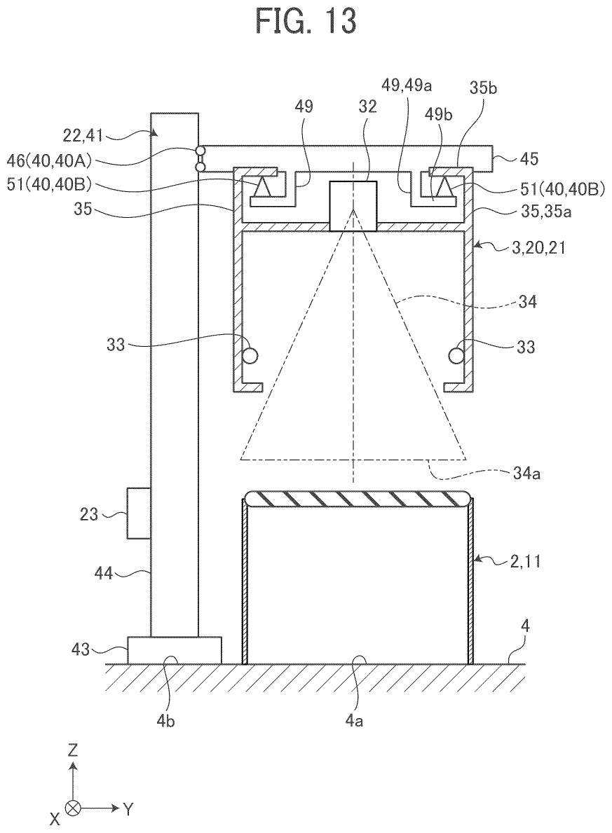

Third Embodiment FIG. 13 is a cross-sectional view of a part of the automatic recyclable waste sorting apparatus 1 including the object recognition apparatus 3 according to the third embodiment.

As illustrated in FIG. 13, the present embodiment is different from the first embodiment in that the optical unit 21 is located below the beam 45, that is, on same side as the belt 12 relative to the beam 45, and is supported by the beam 45.

Specifically, the beam 45 is provided with a hanger 49, and the hanger 49 hangs the optical unit 21. The hanger 49 includes a coupler 49a and a support structure 49b. The coupler 49a is coupled to the beam 45 and extends downward from the beam 45. The support structure 49b extends from the coupler 49a in a direction intersecting (e.g., perpendicular to) the up-down direction. The support structure 49b is also referred to as a “supporter.” The support structure 49b may be inclined relative to the up-down direction. The support structure 49b is provided with the fine adjuster 51. The fine adjuster 51 according to the second embodiment has the same or substantially the same configuration and functions as those described in the first embodiment, and detailed descriptions thereof are omitted below.

The housing 31 of the optical unit 21 is provided with a hung part 35, and the hung part 35 is supported by the hanger 49 via the fine adjuster 51. The hung part 35 includes a coupler 35a and a supported structure 35b. The coupler 35a is coupled to the housing 31 and extends upward from the housing 31. The supported structure 35b extends from the coupler 35a in a direction intersecting (e.g., perpendicular to) the up-down direction. The supported structure 35b may be inclined relative to the up-down direction. In other words, the fine adjusters 51 do not have to be arranged on the same horizontal plane parallel to the upper face 12a of the belt 12, and may be arranged on a plane oblique to the upper face 12a of the belt 12. In other words, the positions of the fine adjusters 51 in the height direction (i.e., the up-down direction) may be different from each other. This may reduce design constraints and result in a simpler structure. The above-described arrangement of the fine adjusters 51 is applicable to the first and second embodiments in addition to the third embodiment. The supported structure 35b is supported by the fine adjuster 51.

As described above, in the present embodiment, the optical unit 21 is located on the same side as the belt 12 relative to the beam 45 and is supported by the beam 45.

With such a configuration, the optical unit 21 can be easily brought closer to the belt 12.

In the above-described embodiments, an example in which the position (height) of the beam 45 relative to the pillar 44 is adjusted by selecting the through-holes 44c of the first adjuster 40A of the support structure 22 is described, but the disclosure is not limited thereto. For example, the first adjuster 40A may adjust the position of the beam 45 by moving the beam 45 in the up-down direction relative to the pillar 44 with a worm gear and screw the beam 45 of which the position has been adjusted to the pillar 44. Alternatively, the pillar 44 may have a two-stage structure that enables the pillar 44 to extend and contract in the up-down direction, and the position of the beam 45 may be adjusted by the extraction and contraction of the pillar 44.

In the above-described embodiments, an example in which the spacer 53 is used as the second adjuster 40B of the support structure 22 is described, but the disclosure is not limited thereto. For example, the second adjuster 40B may have a configuration including a screw pin and a double nut, or a pantograph-type configuration.

In the above-described embodiments, the plane M1, the imaging face 34a, and the face to be imaged may be parallel to each other or may be inclined relative to each other. Further, the plane M1, the imaging face 34a, and the face to be imaged may be set at predetermined heights.

The position of the imaging face 34a may be adjusted relative to the face to be imaged by using a caliper or a steel square. Further, the height of the second adjuster 40B may be adjusted by placing a height adjustment box on the belt conveyor 2 and placing a transparent plate on the second adjuster 40B so that the upper face of the adjustment box and the lower face of the transparent plate are in contact with each other.

An object to be imaged or recognized in the above-described embodiments is not limited to recyclable waste. The object to be imaged or recognized in the above-described embodiments may be, for example, an object to be inspected or an object to be sorted. The object to be inspected and the object to be sorted may be a product such as a manufactured product, an agricultural product, and a marine product.

According to the related art, an object imaging apparatus is installed on a belt conveyor. Accordingly, when the belt conveyor is preliminarily installed in a facility, one has to check whether the object imaging apparatus can be installed on the belt conveyor. This takes time and efforts.

According to one or more embodiments, the object imaging apparatus and the object recognition apparatus can be easily installed even when the conveying apparatus is preliminarily located.

The above-described embodiments are illustrative and do not limit the present disclosure. Thus, numerous additional modifications and variations are possible in light of the above teachings. The above-described elements can be combined with each other appropriately. Some of the elements of the above-described embodiments may be omitted, substituted for each other, and/or changed within the scope of the present disclosure.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An object imaging apparatus, comprising:
an imaging device facing a conveyor that conveys an object to image the object conveyed by the conveyor;
a first supporter that is located on the same side as the imaging device relative to the conveyor with a space from the conveyor and is to support the imaging device; and
a second supporter that is located in a second installation portion different from a first installation portion in which a conveying device including the conveyor is located and is to support the first supporter,
wherein the second supporter is provided only on one side with respect a width direction of the conveyor.

2. The object imaging apparatus according to claim 1, wherein the second supporter supports the first supporter in a cantilever manner.

3. The object imaging apparatus according to claim 1, wherein the first supporter includes two beams provided at an interval in a conveying direction in which the object is conveyed.

4. The object imaging apparatus according to claim 1, further comprising a support structure that includes the first supporter and the second supporter and is to adjust a position of the imaging device relative to the conveyor in a facing direction in which the conveyor and the imaging device face each other.

5. The object imaging apparatus according to claim 4, wherein the support structure includes a position adjuster to adjust at least one of a position of the first supporter relative to the second supporter in the facing direction in which the conveyor and the imaging device face each other and a position of the imaging device relative to the first supporter in the facing direction.

6. The object imaging apparatus according to claim 4, wherein the support structure adjusts a posture of the imaging device.

7. The object imaging apparatus according to claim 5,
wherein the position adjuster includes:
a first adjuster to couple the second supporter and the first supporter to each other to adjust a position of the first supporter relative to the second supporter in the facing direction; and
a second adjuster to couple the imaging device to the first supporter to adjust a position of the imaging device relative to the first supporter in the facing direction, and
wherein an amount by which the position of the imaging device can be adjusted by the second adjuster is smaller than an amount by which the position of the imaging device can be adjusted by the first adjuster.

8. The object imaging apparatus according to claim 1, wherein the imaging device is located opposite the conveyor relative to the first supporter and is supported by the first supporter.

9. The object imaging apparatus according to claim 1, wherein the imaging device is located on the same side as the conveyor relative to the first supporter and is supported by the first supporter.

10. The object imaging apparatus according to claim 1, further comprising:
a pair of plates spaced apart in a width direction of the conveyor and sandwiching a space between the imaging device and the conveyor; and
a plate position adjuster to adjust at least one of a distance between the pair of plates in the width direction and positions of the pair of plates in a facing direction in which the conveyor and the imaging device face each other,
wherein the imaging device images the object between the pair of plates.

11. The object imaging apparatus according to claim 1,
wherein the imaging device includes:
a housing facing the conveyor;
an imager to image the object conveyed by the conveyor through an inside of the housing; and
a light source to emit light to the inside of the housing, and
wherein the housing includes a reflection face that reflects the light from the light source toward the conveyor.

12. The object imaging apparatus according to claim 11, wherein the imager is an area image sensor.

13. An object recognition apparatus, comprising:
the object imaging apparatus according to claim 1; and
circuitry configured to recognize the object based on a captured image obtained by imaging the object by the imaging device.

14. An imaging apparatus comprising:
an imaging device including:
a housing having an opening;
a light source disposed inside the housing and configured to illuminate an object through the opening; and
an imager disposed inside the housing and configured to capture the illuminated object through the opening; and
a cantilever beam assembly including:
a pillar;
a cantilever beam having:
a free end extending from the pillar; and
a fixed end attached to the pillar, wherein the cantilever beam assembly is configured to support the imaging device, and an optical axis of the imager is parallel to the pillar.

15. The imaging apparatus according to claim 14,
wherein the object is transported by a conveyer, and
wherein the cantilever beam assembly further includes a base configured to support the pillar, and the base is not a part of the conveyer.
